(19) United States
(12) Patent Application Publication
(10) Pub. No.: US 2011/0290093 A1
(43) Pub. Date: Dec. 1, 2011

(54) CUTTER AND PRINTER

(75) Inventors: Masayoshi Kikuchi, Miyagi (JP); Kenichi Kimura, Miyagi (JP)

(73) Assignee: TOSHIBA TEC KABUSHIKI KAISHA, Tokyo (JP)

(21) Appl. No.: 13/118,861

(22) Filed: May 31, 2011

(30) Foreign Application Priority Data
May 31, 2010 (JP) 2010-124668

(51) Int. Cl. B26D 1/18

(52) U.S. Cl. 83/485

(57) ABSTRACT

Embodiments described herein are to a cutter including a carriage, a rotary blade mounted on the carriage, the rotary blade including a second blade edge on an outer circumferential part of the rotary blade, a fixed blade including a first blade edge, and a moving mechanism configured to move the carriage along the first blade edge of the fixed blade. The cutter further includes a rotation driving mechanism configured to drive the rotary blade to rotate in conjunction with the movement of the carriage, in a cutting direction.

### CROSS-REFERENCE TO RELATED APPLICATIONS

This application is based upon and claims the benefit of priority from Japanese Patent Application No. 2010-124668, filed on May 31, 2010, the entire contents of which are incorporated herein by reference.

### FIELD

Embodiments describe herein relate generally to a cutter device and a printer.

### BACKGROUND

A cutter includes an elongated fixed blade and a disc-shaped rotary blade, which cuts paper by moving the rotary blade along the fixed blade.

In such a cutter, the rotary blade is rotated while being moved along the fixed blade, so that the load required for the rotary blade to cut an object to be cut (or friction between the object and the blade) is reduced, thereby allowing the object to be smoothly cut.

However, in the above-described cutter, the rotation of the rotary blade is driven by a sliding resistance (or friction) between the fixed blade and the rotary blade or sliding resistance between the rotary blade and the paper, which is caused by moving the rotary blade along the fixed blade. In this case, fiber clumps produced in the paper cutting process and abrasion of the blade edge portion may affect the cutting process. Due to such problems, the rotary blade may have difficulty in rotating to cut the paper smoothly.

### BRIEF DESCRIPTION OF THE DRAWINGS

FIG. 1 is a schematic view showing a configuration of a printer according to a first embodiment.

FIG. 2 is a perspective view showing a fixed blade and a rotary blade of a cutter.

FIG. 3 is a side view showing the fixed blade and the rotary blade of the cutter.

FIG. 4 is a perspective view showing the cutter.

FIG. 5 is a perspective view showing a part of the cutter.

FIG. 6 is a side view showing a moving body of the cutter and its peripheral area.

FIG. 7 is an exploded perspective view showing the moving body of the cutter.

FIG. 8 is an exploded perspective view showing a part of a carriage and a rotary member.

FIG. 9 illustrates the positional relation between the rotary blade and the rotary member.

FIG. 10 is a side view showing a moving body and its peripheral area in a cutter according to a second embodiment.

FIG. 11 is an exploded perspective view showing a part of a carriage and a rotary member.

### DETAILED DESCRIPTION

According to one embodiment, a cutter includes a carriage, a rotary blade mounted on the carriage, the rotary blade including a second blade edge on an outer circumferential part of the rotary blade, and a fixed blade including a first blade edge. The cutter further includes a moving mechanism configured to move the carriage along the first blade edge of the fixed blade; and a rotation driving mechanism configured to drive the rotary blade to rotate in conjunction with the movement of the carriage, in a cutting direction.

Embodiments will now be described in detail with reference to the drawings. Same components may be included in a plurality of embodiments to be described below. Therefore, the same reference numerals are allocated to the same components and duplicate descriptions are omitted.

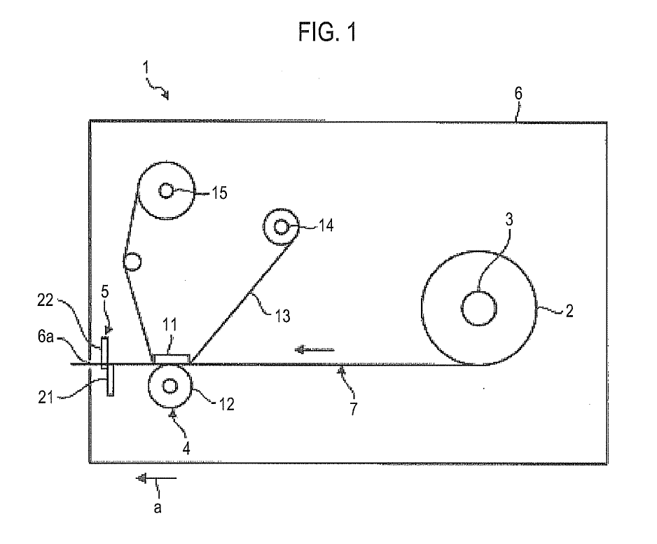

A first embodiment will be described referring to FIGS. 1 to 9. An arrow a in the drawings indicates a forward direction along a horizontal lateral direction of a printer and a cutter, and an arrow b indicates a width direction thereof.

As shown in FIG. 1, a printer 1 includes a paper holder 3 configured to hold a paper 2, a printing unit 4 configured to convey the paper 2 and print information on the paper 2, and a cutter 5 provided downstream in a paper conveying direction of the printing unit 4 and configured to cut the paper 2. The paper holder 3, the printing unit 4 and the cutter 5 are provided within a case 6. In the present embodiment, the paper 2 may be a label paper where a plurality of labels are attached on an elongated strip-shaped backing sheet (or a web material) and is held by the paper holder 3, being wound into a roll shape.

The printing unit 4 includes a thermal head 11 and a platen roller 12. The thermal head 11 and the platen roller 12 are placed to face each other and a paper conveyance path 7 is formed therebetween, along which the paper 2 is conveyed. The thermal head 11 is configured to be biased toward the platen roller 12 by means of a biasing member such as a coil spring (not illustrated in the drawing). An ink ribbon 13 is configured to be suspended with tension by the thermal head 11. The ink ribbon 13 is supported by two ribbon cores 14 and 15 with both ends of the ink ribbon 13 wound around the two ribbon cores, respectively. An unused part of the ink ribbon 13 is wound around the ribbon core 14 while a used part thereof is wound around the ribbon core 15. The platen roller 12 is connected to a motor used as a driving source (not illustrated) so that the motor drives the platen roller 12 to rotate. The rotation of the platen roller 12 causes the paper 2 to be conveyed while being inserted between the platen roller 12 and the thermal head 11. As such, the printing unit 4 including the platen roller 12 and the thermal head 11 also functions as a conveying unit.

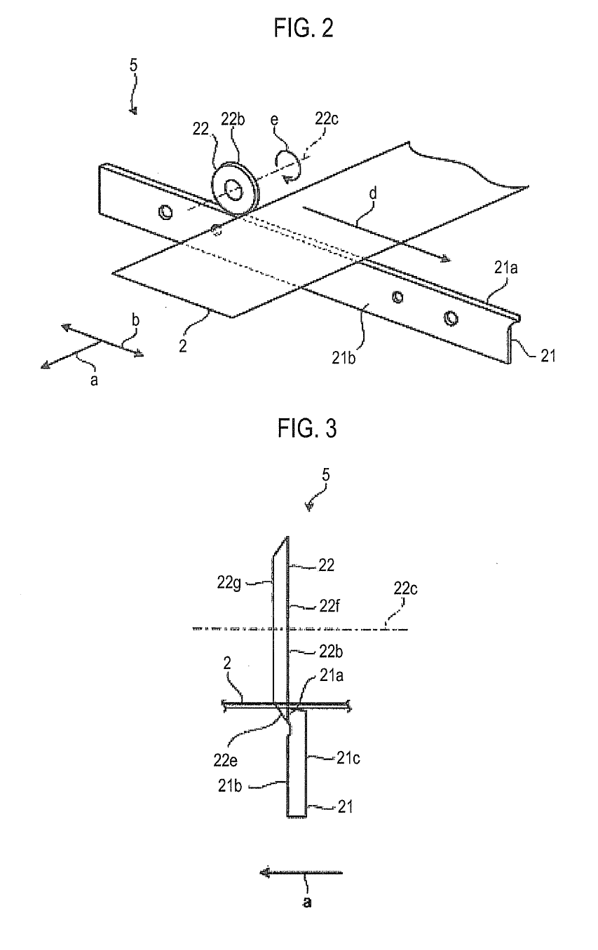

As shown in FIGS. 2 and 3, the cutter 5 includes a fixed blade 21 and a rotary blade 22 configured to be reciprocated along the fixed blade 21. The cutter 5 is configured to cut the paper 2 (as an object to be cut) by the fixed blade 21 and the rotary blade 22 such that the rotary blade 22 is driven to rotate while moving in a traverse direction of the paper 2 along the fixed blade 21.

In the configuration of printer 1 above, the paper 2, being inserted between the thermal head 11 and the platen roller 12, is conveyed by the rotation of the platen roller 12, while the thermal head 11 performs printing on the paper 2. The ink applied on the ink ribbon 13 may be melted by heating an appropriate heating element from a plurality of heating elements of the thermal head 11. The melted ink transfers onto the paper 2 and thus is printed on the paper 2. Once printing is completed, paper 2 is cut by the cutter 5 and then is discharged through a paper outlet 6a formed in the case 6. The above operation may be performed by controlling the printing unit 4 and the cutter 5 by a control unit (not illustrated in the drawings).

In the following, the cutter 5 will be described in detail.

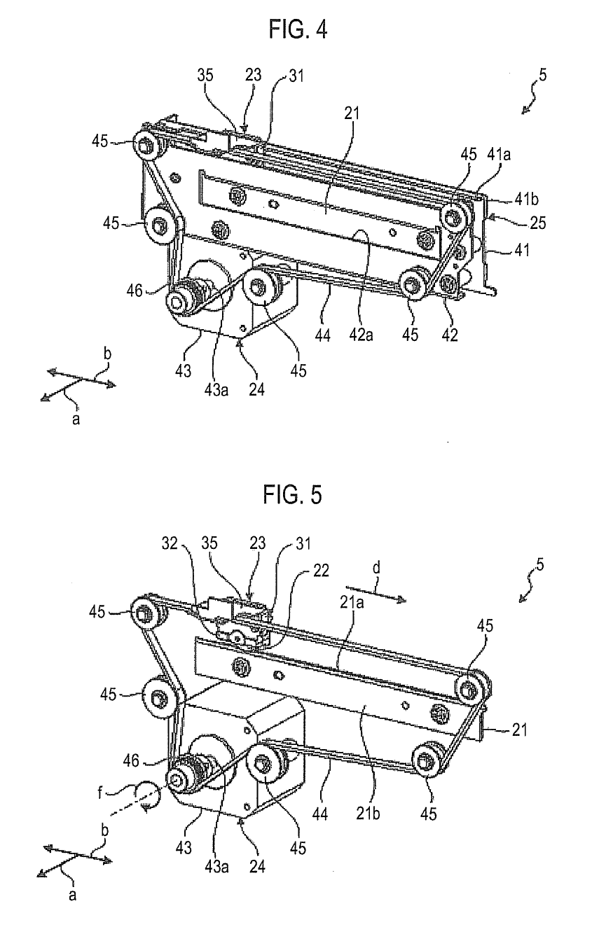

As illustrated in FIGS. 4 and 5, the cutter 5 includes the above-described fixed blade 21 and rotary blade 22. Further, the cutter 5 includes a carriage 23 in which the rotary blade 22 is rotatably mounted, a moving mechanism 24 configured to move the carriage 23 along a first blade edge 21a of the fixed blade 21, and a rotation driving mechanism 25 configured to drive the rotary blade 22 to rotate in conjunction with the movement of the carriage 23.

The fixed blade 21 has an elongated plate shape extending along a widthwise direction of the cutter 5. Formed in an edge portion in a thickness direction of the fixed blade 21 is the first blade edge 21a. The first blade edge 21a is formed linearly (specifically in a straight line) along the width direction of the cutter 5. In other words, the first blade edge 21a is formed in a straight line along the paper width direction which is perpendicular to the paper conveying direction (i.e., the direction indicated by the arrow a in the drawings). The first blade edge 21a is disposed to face the paper conveyance path 7. Further, the fixed blade 21 includes two surfaces 21b and 21c, which face outward in opposite directions. Specifically, the surface 21b of the fixed blade 21 is configured to guide the rotary blade 22. The fixed blade 21 is made of, e.g., metal.

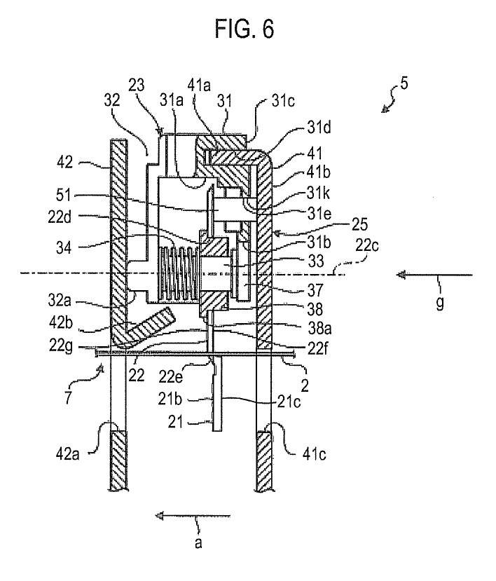

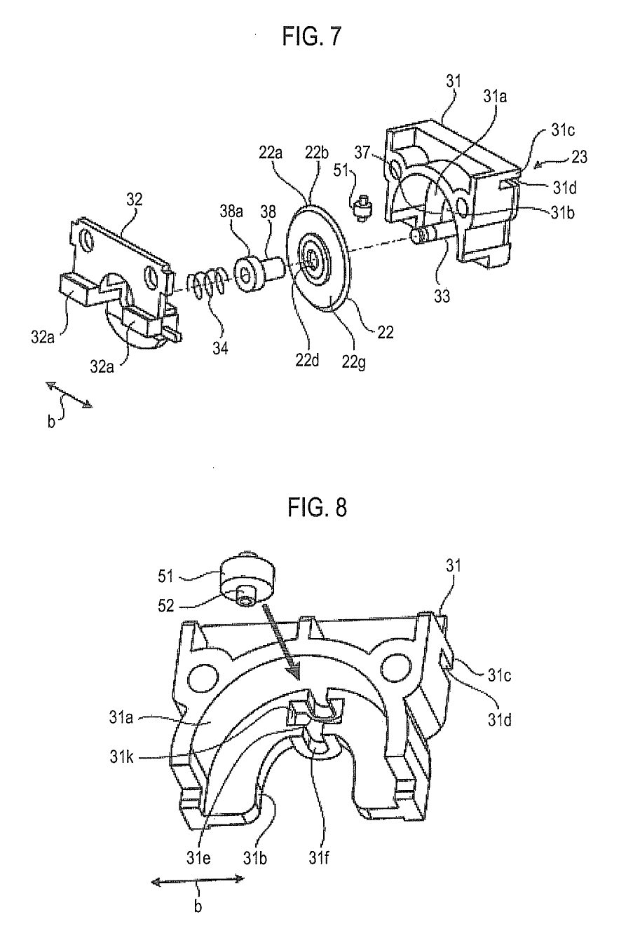

As shown in FIGS. 6 and 7, the rotary blade 22 is disc shaped. The rotary blade 22 includes a second blade edge 22b in an outer circumferential portion thereof. The second blade edge 22b is ring shaped. The rotary blade 22 is configured to rotate along a rotation axis 22c disposed to be perpendicular to the diameter direction of the rotary blade 22 (i.e., along the thickness direction of the rotary blade 22). Specifically, an axis hole 22d is formed in the center part of the rotary blade 22 to pass through the rotary blade 22 in the thickness direction thereof. Into the axis hole 22d, an axis member 33 is inserted via a bearing 38. In this way, the rotary blade 22 is rotatably supported by the axis member 33 via the bearing 38.

A portion 22e of the rotary blade 22, which includes a part of the second blade edge 22b, overlaps with the fixed blade 21 (in the direction of the rotation axis 22c of the rotary blade 22) to be in contact with the fixed blade 21. Specifically, the rotary blade 22 includes two surfaces 22f and 22g, which face outwards in opposite directions. Further, the surface 22f of the rotary blade 22 is configured to be in contact with the surface 21b and the first blade edge 21a of the fixed blade 21. The rotary blade 22 is made of, for example, metal.

The rotary blade 22 cuts the paper 2 in cooperation with the fixed blade 21 by rotating in the direction of arrow e, illustrated in FIG. 2, when the paper 2 is interposed between the rotary blade 22 and the first blade edge 21a of the fixed blade 21 (hereinafter, referred to as a cutting direction) while moving along the first blade edge 21a together with the carriage 23. For example, when the rotary blade 22 moves in conjunction with the carriage 23 in the direction of arrow d in FIG. 2, it rotates in the direction of arrow e.

As shown in FIGS. 6 and 7, the carriage 23 includes a first frame member 31 and a second frame member 32 which are connected to face each other, the axis member 33 provided between the first frame member 31 and the second frame member 32 and configured to rotatably support the rotary blade 22. The carriage 23 further includes a coil spring 34 as a biasing member configured to apply a bias force to the rotary blade 22 against the fixed blade 21, and a belt connecting part 35 (referring to FIG. 5). The carriage 23 in combination with the rotary blade 22 constitutes a moving body.

The first frame member 31 may be formed of resin or metal and the like. The first frame member 31 includes a blade accommodation part 31a configured to accommodate a part of the rotary blade 22, as shown in FIGS. 6 to 8. Formed in the blade accommodation part 31a is a wedge-shaped fixing part 31b configured to fix one end of the axis member 33 thereto (referring to FIG. 8). Further, the first frame member 31 includes a fitting part 31c which slidably fits with a first guide member 41 (to be described later) of the moving mechanism 24. Formed in the fitting part 31c is a groove 31d into which the first guide member 41 is fitted. The belt connecting part 35 is fixed to the first frame member 31 by, e.g., bonding, welding, etc. The belt connecting part 35 is, e.g., a plate-shaped member.

The second frame member 32 includes a connecting part (not shown) into which the other end of the axis member 33 is fitted. The second frame member 32 is fastened to the first frame member 31 by means of screws. Formed in the second frame member 32 are convex portions 32a configured to slide in a second guide member 42 (to be described later) of the moving mechanism 24, as presented in FIGS. 6 and 7. A plurality of the convex portions 32a (two convex portions in the present embodiment) are provided to be spaced apart from each other along the moving direction of the carriage 23.

As shown in FIGS. 6 and 7, a plate member 37 is integrally formed at one end of the axis member 33. The axis member 33 is fixed to the fixing part 31b of the first frame member 31 by way of the plate member 37. The plate member 37 may be attached to the fixing part 31b through bonding, welding, etc. The axial direction of the axis member 33 is orthogonal to the moving direction of the carriage 23 and approximately parallel to the paper conveying direction. A part of the axis member 33 is located within the blade accommodation part 31a. The rotary blade 22 is rotatably supported by the axis member 33. Specifically, the rotary blade 22 is supported by the axis member 33 via the bearing 38. The axis member 33 is connected via the bearing 38 to the axis hole 22d formed at the center of the rotary blade 22, thereby rotatably supporting the rotary blade 22. In the present embodiment, the bearing 38 may be, e.g., a ball bearing. Viewed from the front (in other words, viewed along the axial direction of the axis member 33), the axis member 33 is arranged between the two convex portions 32a of the second frame member 32.

A flange 38a (used as an engaging part) configured to engage with the other surface 22g of the rotary blade 22 is formed to protrude on an outer circumferential part of the bearing 38.

As presented in FIG. 6, the coil spring 34 may be disposed in a compressed state between the second frame member 32 and the bearing 38, to thereby encircle the axis member 33. The coil spring 34 applies a biasing force to the rotary blade 21 against the fixed blade 21 via the bearing 38, which is engaged with the rotary blade 22 by the flange 38a, thereby making the surface 22f of the rotary blade 22 come in contact with the surface 21b of the fixed blade 21.

The moving mechanism 24 is configured to move the carriage 23 mounting the rotary blade 22 therein along the first blade edge 21a of the fixed blade 21. As shown in FIG. 4, the moving mechanism 24 includes a first guide member 41 and a second guide member 42 configured to guide the carriage 23, a motor 43 as a driving source configured to drive the carriage 23, and an endless belt 44 configured to connect the motor 43 to the carriage 23. FIG. 5 shows the cutter 5 without the first and the second guide members 41 and 42.

The first and the second guide members 41 and 42 are configured to be displaced with respect to the fixed blade 21. Specifically, the second guide member 42 being screwed to the first guide member 41, the first guide member 41 is screwed to the case 6. Further, the first and the second guide members 41 and 42 are configured to support the carriage 23, with the carriage 23 being interposed therebetween.

The first guide member 41 is disposed along the width direction of the cutter 5. The first guide member 41 is constituted by connecting a first plate 41a and a second plate 41b to each other to form an approximately “L” shape when viewed from the side. The first plate 41a is fitted into the fitting part 31c of the carriage 23. The second plate 41b is disposed approximately parallel with the surface 22f of the rotary blade 22. A first paper insert hole 41c for inserting the paper 2 therethrough is provided in the first guide member 41. In the present embodiment, the first guide member 41 is disposed along the first blade edge 21a and functions as a fixed member whose position is determined with respect to the first blade edge 21a.

The second guide member 42 is disposed along the width direction of the cutter 5. The second guide member 42 is formed in an approximately flat plate shape. A rectangular second paper insert hole 42a for inserting the paper 2 therethrough is formed in the second guide member 42. At one edge of the paper insert hole 42a, a bent part 42b is provided to guide the paper 2.

As presented in FIG. 5, the endless belt 44 extends with tension around a plurality of pulleys 45 and is fixed to the belt connecting part 35 of the carriage 23. The endless belt 44 may be fixed to the belt connecting part 35 by, e.g., screwing, tying, bonding, etc. The endless belt 44 may be a timing belt, and the pulleys 45 may be toothed pulleys. A driving gear 46 configured to be tooth-engaged with the endless belt 44 is fixed to a rotating axis 43a of the motor 43.

In the moving mechanism 24, rotation of the rotating axis 43a of the motor 43 causes the endless belt 44 to turn around, thereby moving the carriage 23 along the first blade edge 21a of the fixed blade 21. At this time, the moving mechanism 24 causes the carriage 23 to move in one direction along the first blade edge 21a of the fixed blade 21 (e.g., direction of an arrow d in FIG. 5) by rotating the rotating axis 43a of the motor 43 in one direction (e.g., direction of an arrow f in FIG. 5). On the other hand, the moving mechanism 24 causes the carriage 23 to move in the other direction along the first blade edge 21a (e.g., opposite direction to the arrow d in FIG. 5) by rotating the rotating axis 43a of the motor 43 in the other direction (e.g., opposite direction to the arrow f in FIG. 5.) In other words, the moving mechanism 24 enables the carriage 23 to reciprocate along the first blade edge 21a.

As shown in FIG. 6, the rotation driving mechanism 25 includes the second plate 41b of the first guide member 41 (used as a fixed member), and a rotary member 51 (used as a converting part) which is mounted in the carriage 23, being interposed between the second plate 41b and the rotary blade 22.

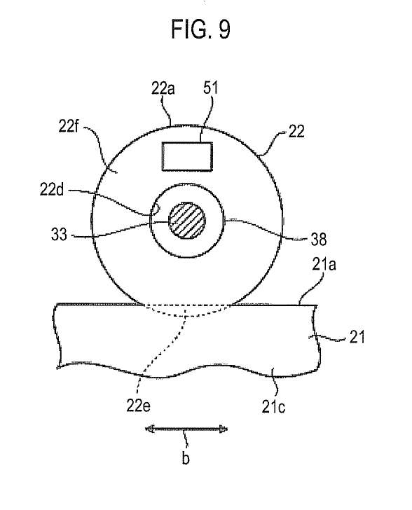

The rotary member 51 performs the conversion of the movement of the carriage 23 (i.e., linear movement in the present embodiment) into the rotation of the rotary blade 22 in the cutting direction. In this embodiment, the rotary member 51 may be a ball bearing having a cylindrical shape. The ball bearing may have a well-known structure where a plurality of balls is disposed between a ring member formed in the inner circumferential side and another ring member formed in the outer circumferential side. The rotary member 51 is inserted into a through hole 31e formed in the first frame member 31, as shown in FIGS. 6 to 8. An axis member 52 is inserted and fixed to the ring member formed in the inner circumferential side of the rotary member 51. This axis member 52 is supported by a supporting part 31f formed in the first frame member 31 of the carriage 23. The rotary member 51 is positioned between the surface 22f of the rotary blade 22 and the second plate 41b, and tightly interposed therebetween by the biasing force applied by the coil spring 34. With this structure, the rotary member 51 is rotatably mounted in the carriage 23 and moved together with the carriage 23. Specifically, the ring member formed in the outer circumferential side of the rotary member 51 is configured to be rotatable in the present embodiment. In this embodiment, at least the outer circumferential ring member of the rotary member 51 is spaced from a circumferential surface 311c of the though hole 31e. With the above configuration, viewing the rotary member 51 in a direction toward the side 22f of the rotary blade 22 (i.e., along a direction indicated by an arrow g in FIG. 6), a portion 22e (i.e., area in contact with the fixed blade 21) of the side 22f of the rotary blade 22 and the rotary member 51 are positioned to interpose the center part of the rotary blade 22 and the axis member 33 therebetween, as shown in FIG. 9.

While the rotary blade 22 moves along the first blade edge 21a together with the carriage 23, the rotary member 51 rotates by friction between the rotary member 51 and the second plate 41b of the first guide member 41, to thereby drive the rotary blade 22 to rotate. Specifically, while the carriage 23 moves in a direction along the first blade edge 21a of the fixed blade 21 (direction of an arrow d in FIG. 2), the rotary member 51 turns around in the direction of driving the rotary blade 22 to rotate in one direction (e.g., direction of an arrow e in FIG. 2). On the other hand, while the carriage 23 moves in the other direction along the first blade edge 21a (opposite direction of arrow d in FIG. 2), the rotary member 51 changes the direction of driving the rotary blade 22 to rotate in the other direction (opposite direction to the arrow e in FIG. 2). In the structure of the present embodiment, the circumferential velocity of (the second blade edge 22b of) the rotary blade 22 is equal to or greater than the moving velocity of the carriage 23. More particularly, the rotary member 51 rotates the rotary blade 22 by making contact with a point between the second blade edge 22b and the center part of the rotary blade 22, so that the circumferential velocity of the rotary blade 22 is greater than the moving velocity of the carriage 23. In this structure, the closer to the center part of the rotary blade 22 the rotary member 51 is positioned, the faster the rotary blade 22 can be rotated.

In the above configuration, the rotary blade 22 moves along the first blade edge 21a of the fixed blade 21 together with the carriage 23 by the driving of the motor 43, during which the rotary member 51 converts the movement of the carriage 23 to the rotational motion of the rotary blade 22 in the cutting direction. In this manner, the rotary blade 22 cuts the paper 2 in cooperation with the fixed blade 21. As a result, the cutter 5 according to the present embodiment cuts the paper 2 with the rotary blade 22 and the fixed blade 21 by rotating the rotary blade 22, which is driven by the movement of the carriage 23, in the course of moving the carriage 23 along the first blade edge 21a, the carriage 23 rotatably supporting the rotary blade 22 and the first blade edge 21a provided along the longitudinal direction of the fixed blade 21.

As explained above, the cutter 5 in the present embodiment includes the rotary member 51 as the converting part configured to convert the movement of the carriage 23 into the rotational motion of the rotary blade 22 in the cutting direction. Thus, according to the cutter 5 in the embodiment, the rotary blade 22 moving along the first blade edge 21a of the fixed blade 21 is driven to rotate by the rotary member 51, thereby suppressing any malfunction in rotation of the rotary blade 22 and enabling a smooth cutting of the paper 2. By rotating the rotary blade 22 in this manner, the load (or resistance) required for cutting the paper 2 is reduced, so that the paper 2 can be more smoothly cut, compared with a configuration without the function of rotating the rotary blade 22 with the rotary member 51. Furthermore, by rotating the rotary blade 22 with the rotary member 51, the entire part of the second blade edge 22b of the rotary blade 22 is evenly used in paper cutting, which results in extending the life of the rotary blade 22 compared with a configuration without rotating the rotary blade 22 with the rotary member 51.

Further, the cutter 5 according to the present embodiment includes the axis member 33 provided in the carriage 23, the two surfaces 22f and 22g provided in the rotary blade 22, facing outward in opposite directions. Further, the cutter 5 includes the coil spring 34 provided in the carriage 23, which acts as the biasing member configured to apply biasing force to the rotary blade 22 against the fixed blade 21 to thereby keep the surface 22f in contact with the fixed blade 21, and the first guide member 41 extending along the first blade edge 21a, which acts as the fixed member whose position is determined with respect to the fixed blade 21. The axis member 33 is connected to the center part of the rotary blade 22 and thus rotatably supports the rotary blade 22. The rotary member 51 (used as the converting part) is mounted in the carriage 23 and is interposed between the surface 22f of the rotary blade 22 and the first guide member 41 used as the fixed member. Accordingly, the rotary member 51 controls the rotary blade 22 not to tilt along the contact part between the rotary blade 22 and the fixed blade 21, which enables quality cutting of the paper 2. As such, the rotary member 51 acts as a tilt control member which restrains the tilting of the rotary blade 22.

Further, the rotary member 51 used as the converting part in the present embodiment is a ball bearing. Therefore, the rotary member (converting part) can be easily implemented.

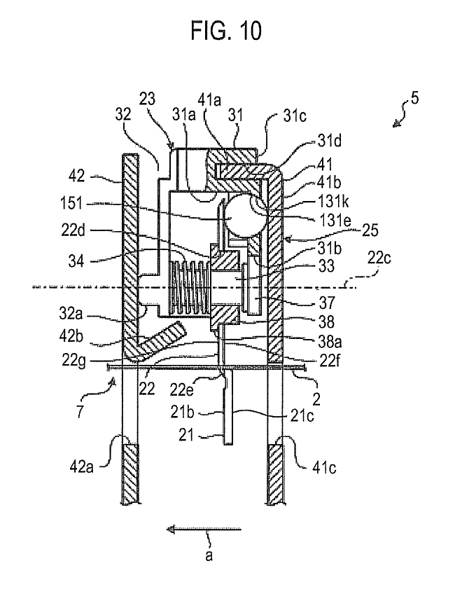

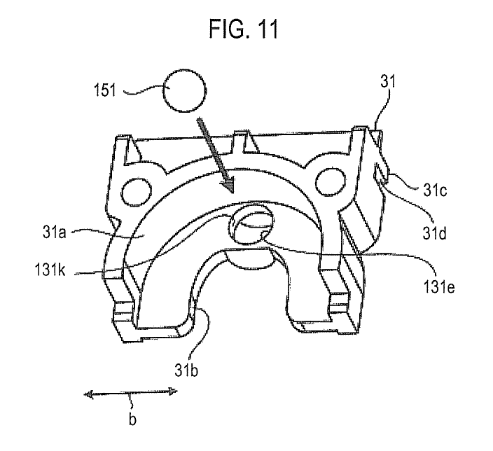

The following is a description of a second embodiment with reference to FIGS. 10 and 11.

The present embodiment may use basically the same configuration as the first embodiment, but differs from the first embodiment in using a rotary member 151 as the converting part.

The rotary member 151 in this embodiment is a spherical body as shown in FIGS. 10 and 11. In one embodiment, the spherical body may be implemented using a steel ball having relatively high rigidity. Provided in the first frame member 31 of the carriage 23 is a through hole 131e into which the rotary member 151 is inserted. The through hole 131e is configured so that the diameter thereof becomes smaller towards the second plate 41b, such that the shape of the through hole 131e roughly fits with the shape of the rotary member 151. The rotary member 151 is fitted with the through hole 131e so that it can slide with respect to the circumferential surface 131k of the through hole 131e. The rotary member 151 is positioned between the surface 22f of the rotary blade 22 and the second plate 41b, and tightly interposed therebetween by the bias force applied by the coil spring 34. With this structure, the rotary member 151 is rotatably mounted in the carriage 23 and moved together with the carriage 23.

In accordance with the cutter 5 in the present embodiment as described above, the rotary blade 22 moving along the first blade edge 21a of the fixed blade 21 is forcibly driven to rotate by the rotary member 151, thereby suppressing any malfunction in rotation of the rotary blade 22 and enabling quality cutting of the paper 2, in the same manner as in the first embodiment.

In relation to the above configuration, according to the first embodiment, a condition may be caused between a part of the rotary member 51 and the rotary blade 22 along the diameter direction of the rotary blade 22 wherein the rotary blade 22 spins too fast and slips due to the relatively large contact between the rotary member 51 and the rotary blade 22. In contrast, the present embodiment employs a spherical body as the rotary member 151. With this configuration, contact between the rotary member 151 and the rotary blade 22 becomes relatively smaller, which prevents the above-discussed condition between the rotary member 151 and the rotary blade 22.

As explained above, in accordance with the cutter 5 of the first and the second embodiments, the paper 2 can be smoothly cut by suppressing any malfunction in rotation of the rotary blade 22.

In some embodiments, the fixed member may be installed separately from the first guide member 41.

In some other embodiments, a plurality of teeth may be formed on the rotary member 51 and the fixed member to engage with each other. Also, such tooth-engagement structure may be employed in the rotary member 51 and the rotary blade 22 to engage with each other.

Further, in some embodiments, the object to be cut may be a film, cloth tape, and so on.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A cutter comprising:
a carriage;
a rotary blade mounted on the carriage, the rotary blade including a second blade edge on an outer circumferential part of the rotary blade;
a fixed blade including a first blade edge;
a moving mechanism configured to move the carriage along the first blade edge of the fixed blade; and
a rotation driving mechanism configured to drive the rotary blade to rotate in conjunction with the movement of the carriage, in a cutting direction.

2. The cutter of claim 1, wherein the rotation driving mechanism comprises:
a converting part configured to convert the movement of the carriage into the rotational motion of the rotary blade in the cutting direction.

3. The cutter of claim 2, wherein the rotation driving mechanism further comprises a fixed member disposed along the first blade edge, whose position is determined with respect to the first blade edge,
wherein the converting part is configured to convert the movement of the carriage into the rotational motion of the rotary blade by a friction between the converting part and the fixed member.

4. The cutter of claim 3, further comprising:
an axis member provided in the carriage and connected to a center part of the rotary blade to rotatably support the rotary blade;
a pair of surfaces formed in the rotary blade, which face outward in opposing relation to each other in a direction of a rotation center axis of the rotary blade; and
a biasing member provided in the carriage and configured to apply a biasing force to the rotary blade against the fixed blade to make a first surface of the pair of surfaces in contact with the fixed blade,
wherein the converting part is mounted in the carriage and interposed between the first surface and the fixed member.

5. The cutter of claim 2, wherein the converting part is a ball bearing.

6. The cutter of claim 5, wherein the ball bearing comprises a plurality of balls disposed between a first ring member formed in an inner circumferential side of the ball bearing and a second ring member formed in an outer circumferential side of the ball bearing,
wherein the axis member is inserted and fixed to the ring member formed in the inner circumferential side of the ball bearing.

7. The cutter of claim 2, wherein the converting part is a spherical body.

8. The cutter of claim 7, wherein the carriage comprises a through hole into which the spherical body is inserted, the through hole being configured so that the spherical body is slidable with respect to a circumferential surface of the through hole.

9. A cutter for cutting an object to be cut, the cutter comprising:
a fixed blade provided with a first blade edge along a longitudinal direction of the fixed blade;
a rotary blade; and
a carriage configured to rotatably support the rotary blade,
wherein the rotary blade and fixed blade are positioned so that when the cutter performs cutting of the object, the rotary blade, which is driven by the movement of the carriage, moves along the first blade edge.

10. The cutter of claim 9, further comprising a converting part configured to convert the movement of the carriage into the rotational motion of the rotary blade.

11. The cutter of claim 10, further comprising a fixed member disposed along the first blade edge, whose position is determined with respect to the first blade edge,
wherein the converting part is configured to convert the movement of the carriage into the rotational motion of the rotary blade by a friction between the converting part and the fixed member.

12. The cutter of claim 11, further comprising:
an axis member provided in the carriage and connected to a center part of the rotary blade to rotatably support the rotary blade;
a pair of surfaces formed in the rotary blade, which face outward in opposing relation to each other in a direction of a rotation center of axis of the rotary blade; and
a biasing member provided in the carriage and configured to apply a biasing force to the rotary blade against the fixed blade to make a first surface of the pair of surfaces in contact with the fixed blade,
wherein the converting part is mounted in the carriage and interposed between the first surface and the fixed member.

13. The cutter of claim 10, wherein the converting part is a ball bearing.

14. The cutter of claim 13, wherein the ball bearing comprises a plurality of balls disposed between a first ring member formed in an inner circumferential side of the ball bearing and a second ring member formed in an outer circumferential side of the ball bearing,
wherein the axis member is inserted and fixed to the ring member formed in the inner circumferential side of the ball bearing.

15. The cutter of claim 10, wherein the converting part is a spherical body.

16. The cutter of claim 15, wherein the carriage comprises a through hole into which the spherical body is inserted, the through hole being configured so that the spherical body is slidable with respect to a circumferential surface of the through hole.

17. A printer comprising:
a conveying unit configured to convey a paper;
a printing unit configured to print on the paper being conveyed by the conveying part;
a carriage located downstream of the printing unit in a direction of conveying the paper;
a rotary blade mounted on the carriage, the rotary blade including a second blade edge on an outer circumferential part of the rotary blade;
a fixed blade including a first blade edge;
a moving mechanism configured to move the carriage along the first blade edge of the fixed blade; and
a rotation driving mechanism configured to drive the rotary blade to rotate in conjunction with the movement of the carriage, in a cutting direction when a paper is interposed between the second blade edge of the rotary blade and the first blade edge of the fixed blade.
